(19) United States
(12) Patent Application Publication
(10) Pub. No.: US 2007/0159965 A1
(43) Pub. Date: Jul. 12, 2007

(54) Method for determining threshold values for traffic control in communication networks with admission control

(76) Inventors: Stefan Kopf, Zell am Main (DE); Michael Menth, Oellingen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/584,974

(22) PCT Filed: Dec. 14, 2004
(86) PCT No.: PCT/EP04/53455

§ 371 Date: Jun. 30, 2006

(30) Foreign Application Priority Data
Jan. 2, 2004 (DE) 10 2004 001 008.0

(51) Int. Cl. H04L 12/26

(52) U.S. Cl. 370/229

(57) ABSTRACT

Disclosed is a method for allocating transmission capacity to a threshold value based on an expected volume of traffic, said threshold value being used for restricting traffic in a communication network featuring threshold—based access controls. According to the inventive method, a portion of transmission capacity is allocated to the threshold value that is least likely to be blocked according to the expected volume of traffic if an amount of free capacity which corresponds to said portion of transmission capacity is available on the links used for transmitting traffic authorized based on the access control, thus allowing for the most balanced or fair allocation of free transmission capacity to threshold value or access controls. Further embodiments of the invention relate to the optimization of the value of the portion of transmission capacity as well as to taking into account disturbance scenarios. In order to take into account disturbance scenarios, the threshold values are set such that buffer capacity is provided for absorbing incidents occurring in the network.

### CROSS REFERENCE TO RELATED APPLICATIONS

This application is the US National Stage of International Application No. PCT/EP2004/053455, filed Dec. 14, 2004 and claims the benefit thereof. The International Application claims the benefits of German application No. 102004001008.0 DE filed Jan. 2, 2004, both of the applications are incorporated by reference herein in their entirety.

### FIELD OF INVENTION

The invention relates to a method for setting a threshold value for traffic control in a communication network comprising nodes and links using threshold-value-based admission controls on the basis of an expected traffic volume.

### BACKGROUND OF INVENTION

Traffic control or limiting—data traffic as well as voice traffic—is a central problem for connectionlessly operating communication networks when traffic with high Quality of Service requirements such as voice data is to be transmitted. Suitable traffic control mechanisms are currently under examination by network specialists, switching technologists and Internet experts.

Possibly the most important development in the network field currently is the convergence of voice and data networks. In future, transmission services having different requirements shall be transmitted over the same network, it becoming apparent that a large portion of communication over networks will in future be handled via connectionlessly operating data networks whose most important representatives are the so-called IP networks(IP: Internet Protocol). The transmission of so-called real-time traffic such as voice or video data over data networks while maintaining Quality of Service features is a prerequisite for successful network convergence. When transmitting real-time traffic over data networks, tight limits must be adhered to particularly in respect of the delay times and loss rate of data packets.

### SUMMARY OF INVENTION

One possibility for real-time transmission over data networks while preserving Quality of Service features is to switch a connection through the entire network, i.e. to determine and reserve the necessary resources in advance of the service. The provision of adequate resources to guarantee the service attributes is then monitored for each connection segment or “link”. Technologies operating in this manner include ATM (asynchronous transfer mode) or the MPLS protocol (MPLS: Multiprotocol Label Switching) which provides for the determining of paths through IP networks. However, these methods have the disadvantage of high complexity and—compared to conventional data networks—low flexibility. State information concerning the flows switched through the network must be stored or checked for the individual links.

A method which avoids the complexity of link-by-link checking or control of resources is the so-called diff-serv concept. This is termed a “stateless” concept, i.e. no state information concerning connections or flows along the transmission path needs to be held available. Instead of this, the diff-serv only provides for admission control at the network edge. For this admission control, packets can be delayed according to their service attributes, and—if necessary—discarded. The terms traffic conditioning or policing, traffic shaping and traffic engineering are also used in this context. The diff-serv concept thus permits differentiation of traffic classes—these are frequently referred to as classes of service—which can be prioritized or handled with lower priority according to the transmission requirements. Ultimately, however, the preservation of service attributes for real-time traffic cannot be guaranteed for data transmission using the diff-serv concept. No mechanisms are available for adapting the real-time traffic transmitted over the network in such a way that the preservation of the service attributes could be reliably assessed.

It is therefore desirable to control the real-time traffic transmitted over a data network well enough to ensure that, on the one hand, service attributes can be guaranteed and, on the other hand, that optimum resource utilization does not take place at the expense of the complexity of connections switched through the network.

An object of the invention is to specify an optimized method for defining threshold values for traffic limiting in a communication network.

This object is achieved by a method according to the independent claim.

We proceed on the assumption of communication network comprised of links and nodes (e.g. an IP (Internet Protocol) network) for which at least part of the traffic reaching said communication network (e.g. the traffic of a traffic class) is subjected to admission control by means of a threshold value, said threshold value specifying a limit, the exceeding of which is prevented by rejection of traffic subjected to said admission control. This allows the prevention of bottlenecks due to excessively high traffic volume in the communication network which would cause a reduction in the Quality of Service of the transport services provided by the communication network. It is assumed that, by means of the threshold values used, different admission controls are carried out for the communication network depending on the routes within the network on which the traffic is to be transported. One example of such admission controls are controls which provide a threshold value for a pair of ingress and egress nodes. Traffic which is to be transported between this ingress node and the egress node undergoes admission control using the corresponding threshold value. If the threshold value is exceeded, rejection then takes place, while any other traffic which is to be transported between another pair of nodes is admitted. Another example is admission controls which use two threshold values, one being assigned to the ingress node and the other to the egress node. Traffic is then admitted if the result of admission control is positive for both the ingress node and the egress node.

The invention relates to determining the threshold values for the admission controls. Any such determining must be fair in the sense that some transmission directions within the network are not disadvantaged compared to others, i.e. the traffic transported in one direction is not more likely to be rejected than that of another direction. For this purpose a traffic volume is assumed (which is quantifiable e.g. by means of a traffic matrix) that has been determined e.g. from empirical values or measured values. It can be assumed, for example, that the actual traffic varies around this expected traffic volume (e.g. variations which follow a Poisson distribution). By means of formulas known from the literature (e.g. Kaufman and Roberts in James Roberts, Ugo Mocci, and Jorma Virtamo, Broadband Network Teletraffic—Final Report of Action COST 242, Springer, Berlin, Heidelberg, 1996), it is possible to calculate the probability p_{b} with which traffic subjected to admission control using a threshold value (or budget) b will be rejected. This probability will also be referred to below as the blocking probability. A fair setting of limits is understood here as defining threshold values resulting in blocking probabilities that are as equal as possible for the different admission controls.

According to the invention, existing spare capacity in the communication network is made available for traffic, a distinction being drawn for the traffic to be transmitted according to the admission control or more specifically the corresponding threshold value, i.e. the traffic streams subjected to the same admission control, e.g. because they have identical ingress and egress nodes, are considered collectively. The spare capacity is made available for particular traffic streams by spare capacity being assigned to the corresponding threshold value(s). This assignment corresponds to increasing the threshold values, i.e. reducing the blocking probability (for a given traffic volume). In order to avoid unequal blocking probabilities as far as possible, a portion of transmission capacity (also referred to below as a link capacity increment) is assigned to the threshold value with the highest blocking probability if sufficient spare capacity is available on the links. If the blocking probability is the same, the traffic volume to be transported on the paths associated with the admission control or threshold value can be used as the criterion (the higher traffic volume is the tiebreaker), the links used for transporting the traffic admitted on the basis of the admission control being considered. For example, in the case of multipath routing, some of the traffic additionally admitted to the network on the basis of the assignment of the portion of transmission capacity generally accrues on the individual links. This can be taken into account by checking whether sufficient spare bandwidth is available on the individual links.

The inventive assignment of a portion of transmission capacity to a threshold value can be carried out step-by-step for a set of threshold values (e.g. for all threshold values), it being advisable to re-calculate the corresponding blocking probability after an assignment of a portion of transmission capacity, so that another threshold value (with a lower blocking probability) receives a bandwidth or capacity allocation in the next step. It is further advisable, in the subsequent steps, to no longer consider threshold values for which assignment of a portion of transmission capacity was not possible in the absence of spare capacity on the links, i.e. to remove these values from the set of threshold values considered.

According to further developments, the portion of transmission capacity, i.e. the link capacity increment, is advantageously set. In the case of an iterative assignment of transmission capacity to the threshold values, it is desirable to use as large portions of transmission capacity as possible in order to limit the number of iterations. On the other hand, a transmission capacity portion must not be so large as to leave insufficient spare bandwidth for a fair assignment of transmission capacity to the other threshold values. A useful approach is to set the link capacity increment proportional to the expected traffic volume (which is subjected to the corresponding admission control using the threshold value) or equal to a minimum link capacity increment (the latter e.g. if the otherwise determined link capacity increment is smaller than the minimum link capacity increment). The link capacity increment can, for example, be set equal or proportional to the expected traffic volume multiplied by a relative spare bandwidth present on a link (spare bandwidth divided by traffic volume to be carried on the link). The minimum of the bandwidth available on the links used can then be assigned to the threshold values.

In this way the spare bandwidth is apportioned according to the traffic volume to be transported (which is assigned to the individual admission controls or threshold values). This apportioning can be improved still further in terms of equal blocking probabilities by checking, when setting the link capacity increment for a threshold value, whether the same or lower blocking probabilities are to be achieved through the apportionment of spare bandwidth for the threshold values still considered by the corresponding assignment of their portion of transmission capacity or link capacity increment and, if not, by reducing the link capacity increment for the threshold value considered until this condition is satisfied.

According to other advantageous further developments, disturbance scenarios are considered. It is desirable, not only during normal operation but also in the event of disturbances or failures, to have limited the traffic volume in the network such that no overload situations can occur e.g. as a consequence of traffic redistribution in response to a failure. For this purpose a set of disturbance scenarios is considered which are caused e.g. by failure of a link or node. For example, the apportionment of the available bandwidth of the individual links to the threshold values in the event of the individual disturbance scenarios can be considered and the link capacity increment can be defined according to the minimum for all such incidents.

For incorporating disturbance scenarios, the link capacity increment can also be set proportional to the traffic volume to be transported by [making it] equal or proportional to the expected traffic volume multiplied by a disturbance-scenario-dependent spare capacity on a link divided by the traffic to be transported over the link in the event of a disturbance and which is subjected to admission control using the threshold values considered. A corresponding determination can be carried out for all the links which are subjected to an admission control with the currently considered threshold value during transport. The link capacity increment used for the assignment (assuming sufficient bandwidth) then emerges as the minimum of the link capacity increments, taking the minimum in respect of the disturbance scenarios and links. This ensures that for each (i.e. including the “worst case”) disturbance scenario, no overload occurs on all the links used for transport. If the minimum of the link capacity increments falls below a minimum link capacity increment, the minimum link capacity increment can be used instead of the determined link capacity increment.

### BRIEF DESCRIPTION OF THE DRAWINGS

The subject matter of the invention will now be explained in greater detail using an example with reference to the accompanying drawings in which:

FIG. 1: shows a flowchart for a method for assigning spare capacity to a threshold value for admission control

FIG. 2: shows a flowchart for a method for setting a portion of transmission capacity for a method according to FIG. 1

FIG. 3 shows a flowchart for an accelerated method for setting portions of transmission capacity

### DETAILED DESCRIPTION OF INVENTION

We proceed on the assumption of a communication network which subjects traffic to be transported to admission controls. In the context of the example, admission controls are differentiated according to the ingress point and egress point of the traffic to be transported, each pair of ingress and egress points (i.e. two edge points or edge nodes) being assigned a threshold value (or budget) for the permissible traffic. This threshold value corresponds to a maximum transmission capacity available to the traffic to be transported between the associated end points. The described procedure for limiting the transmission capacity allows better distribution and control of the traffic streams transported in the communication network.

The issue addressed by the invention is how the threshold values for the admission controls are to be suitably selected, i.e. which capacities are to be reserved on the links of the communication network for the individual admission controls, i.e. for the traffic transported between the associated edge points.

In order to determine suitable threshold values, an expected traffic volume is assumed (e.g. described by a traffic matrix) which provides an assessment of the average traffic to be transported between two edge points. It is additionally assumed that this expected traffic volume exhibits variations which are taken into account e.g. by means of a Poisson distribution around the mean value. On the basis of the distribution of the expected traffic volume around a mean value, the probability of the non-admission of traffic can be calculated by means of a threshold value for an admission control. The expression blocking probability will now also be used to convey this.

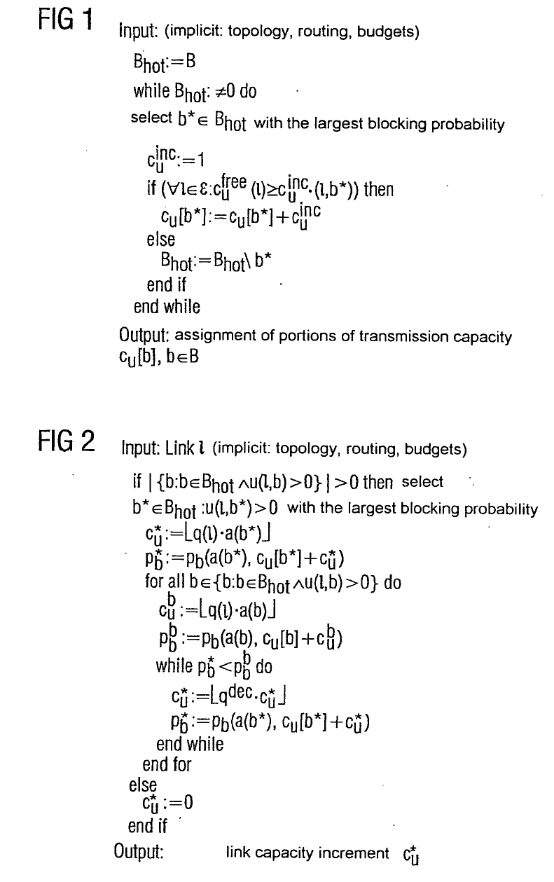

FIG. 1 shows how capacity can be assigned to a threshold value or rather to the corresponding pair of edge points, spare capacity on the links being successively assigned to threshold values. The set of threshold values considered in a step is denoted by Bₕₒₜ. The topology of the communication network, the routing used in the network (e.g. single-path routing or multipath routing) and the type of admission controls or rather threshold values used are implicitly fed into the method. The method according to FIG. 1 is executed as follows:

As long as the set of considered threshold values Bₕₒₜ is not empty, the threshold value (or budget) b* having the largest blocking probability is considered. If there are threshold values with the same blocking probability, the expected traffic volume between the associated edge points (or rather the portion of the expected traffic volume which is subjected to an admission control with the corresponding threshold value) can be used as another selection criterion (the threshold value having the lowest blocking probability and having the highest expected traffic volume is selected). A portion of transmission capacity, i.e. a link capacity increment cᵤ^{inc} is then determined or set. If sufficient spare capacity for the corresponding capacity increase is available for all the links l of the set E of links which are used for transmitting traffic which admitted of the basis of admission control by means of the threshold value b*, the capacity assigned or allocated to the threshold value is increased by the capacity increment cᵤ^{inc}. Expressed mathematically, for all the links l of the set E the condition
cᵤ^{free}(l)≧cᵤ^{inc}*u(l,b*) (1)
must be fulfilled, where u(l,b*) is the portion of the traffic admitted as part of admission control by means of b* which is transmitted over the link l. In the case of single-path routing, u(l,b*)=1. In the case of multipath routing, on the other hand, u(l,b*) is generally less than 1. If the above condition (1) if fulfilled for the links l of E, the capacity assigned to the threshold value b* is increased accordingly:
cᵤ(b*)=cᵤ(b*)+cᵤ^{inc}. (2)
Otherwise b* is no longer considered for the following steps or iterations:
Bₕₒₜ=Bₕₒₜ/b*. (3)

When the set Bₕₒₜ is empty, the method is terminated, i.e. capacities cᵤ(b) have been allocated to the threshold values b.

The method described in FIG. 1 can be accelerated by maximizing the portion of transmission capacity cᵤ^{inc}. A possibility exists therein of setting the portion of transmission capacity cᵤ^{inc} for the threshold value b proportional to the average value a(b) of the traffic subjected to admission control with the threshold value b, e.g.
cᵤ^{inc}=max(l,(q(l)*a(b)/h)) (4)
where l stands for a minimum link capacity increment,
q(l)=cᵤ^{free}(l)/aₕₒₜ(l), where
aₕₒₜ(l)=Σa(b), sum over all b of Bₕₒₜ(l) and
h is a control factor by means of which the method can be adjusted and the number of steps regulated. A possible selection for h is 2. q(l) is a type of link-dependent measure for the ratio between spare bandwidth cᵤ^{free}(l) on this link and the traffic aₕₒₜ(l) accumulated over threshold values b, taking account of those considered threshold values Bₕₒₜ which are responsible for admission controls for traffic transmitted over the link l (i.e. Bₕₒₜ(l)).

This procedure does not necessarily result in a set of threshold values with approximately equal blocking probabilities (corresponding to a fair setting of limits) because threshold values b with a small a(b) need relatively more bandwidth to achieve corresponding blocking probabilities.

One approach for improving the determination described by (4) of a portion of transmission capacity in respect of a fair setting of threshold values is to calculate safe portions of transmission capacity [in such a way] that an assignment of the portion of transmission capacity still permits assignments to the other threshold values considered, allowing a comparable blocking probability to these other threshold values. A possible implementation is described in FIG. 2, where p_{b}* denotes the blocking probability of the threshold value b* which depends on the traffic volume a(b*) expected in the case b* and the capacity cᵤ(b*) assigned to b* or rather the assigned capacity increased by the link capacity increment cᵤ(b*)+cᵤ*. The link capacity increment cᵤ* is initially determined according to (4) (with h=1) and then decremented
cᵤ*=q^{dec}*cᵤ*, (5)
where q^{dec} is a factor less than 1,
until the blocking probability p_{b}* is higher than the blocking probabilities which the other considered threshold values b can attain for a transmission capacity assignment adapted according to a(b). It is therefore ensured using the link capacity increment or portion of transmission capacity calculated in FIG. 2 that sufficient spare capacity is still available for the other considered threshold values b from Bₕₒₜ(l) for comparable blocking probabilities p_{b}^{b}.

A more complex procedure compared to FIG. 2 for setting a portion of transmission capacity for a threshold value b* is the selection
cᵤ^{inc}=max(l, min(q(l)*a(b*)/h)), (6)
taking the minimum min over all the links l for which u(l,b*)>0. The use of (6) in the method according to FIG. 1 is a compromise between fairness and complexity. By selecting h, a situation-dependent adaptation can taken place.

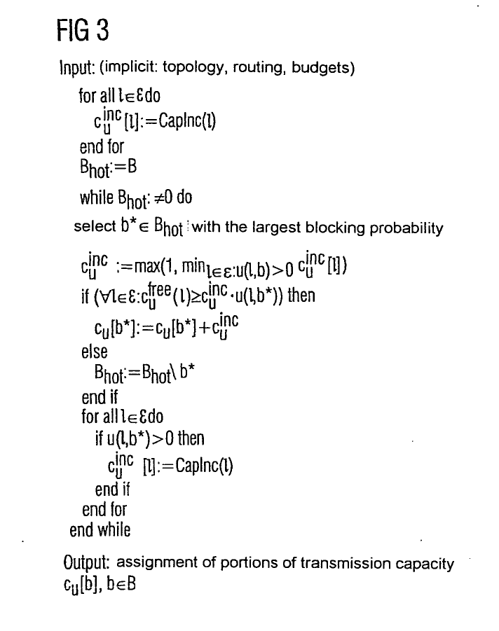

FIG. 3 shows a modification of the method illustrated in FIG. 1, whereby only safe portions of transmission capacity CapInc(I) (CapInc: Calculation of a suitable link capacity increment) are used which are calculated according to FIG. 2 or formula (6).

The subject matter of the invention can be extended to compensate for failures or disturbances. The idea is to provide capacity or more specifically bandwidth for such eventualities. Let S be a set of disturbance scenarios, caused by the failure of at least one link l or node. The function u(s,l,b) shall then describe which portion of the traffic subjected to admission control using threshold value b is routed via the link l in the event of a disturbance s. By means of the method shown in FIG. 1, portions of transmission capacity cᵤ(s,b) can now be calculated for all the disturbance scenarios sεS as a function of the disturbance scenarios sεS and a minimum can be taken therefrom, i.e. cᵤ(b)=min_{sεS} cᵤ(s,b).

A less complex procedure for allowing for disturbance scenarios for determining or setting the portion of transmission capacity or link capacity increment cᵤ^{inc} is given below:

We put
cᵤ^{free}(s,l)=cᵤ(l)−Σcᵤ(b)*u(s,l,b), (7)
the sum running over all bεBₕₒₜ. A link capacity increment cᵤ^{free}(s,l) is defined as a function of disturbance scenario s and the link l by subtracting the capacities already assigned to threshold values b on the link l from the capacity cᵤ(l) available on the link l (for budget or threshold value b the assigned capacity cᵤ(b) and u(s,l,b) is the pro-rata utilization of the link l in the disturbance scenario s). The mean aggregated data or traffic streams coming from the examined threshold values Bₕₒₜ and relating to link l and disturbance scenario s are
aₕₒₜ(s,l)=Σa(b)*u(s,l,b), (8)
where the sum runs over all the bεBₕₒₜ. The ratio q(s,l) of spare capacity to traffic to be transmitted is then given by
q(s,l)=c^{free}(s,l)/aₕₒₜ(s,l) (9)
Finally we get
cᵤ^{inc}=max(l, min(q(s,l)*a(b)/h)),
taking the minimum min over all the disturbance scenarios s and over all the links l for which u(s,l,b)>0. Applying (10) in the method described in FIG. 1 the condition
cᵤ^{free}(l)>cᵤ^{inc}*u(l,b*) (1)
becomes
cᵤ^{free}(s,l)>cᵤ^{inc}*u(s,l,b*).

1.-13. (canceled)

14. A method for assigning transmission capacity to a threshold value for limiting traffic in a communication network, the method comprising:
providing an expected traffic volume subjected to an admission control via the threshold value;
providing a plurality of nodes and a plurality of links using the admission control, the links for the transmission of traffic admitted on the basis of admission control;
assigning a portion of a transmission capacity to the threshold value such that a highest probability of non-admission traffic according to the expected traffic volume is selected; and
increasing the threshold value if an amount of spare capacity corresponding to the portion of transmission capacity is available on the links.

15. The method according to claim 14,
wherein a traffic distribution is performed within the network, and
wherein the assignment occurs if an amount of spare capacity on the links corresponding to a capacity increment reduced according to the portion transmitted over a relevant link is available.

16. The method according to claim 14, further comprising:
providing a set of threshold values used for admission controls; and
executing the method iteratively while the set is not empty,
wherein for each iteration a threshold value having the highest probability of non-admission of traffic the is selected from the set, and
wherein for insufficient spare capacity the assignment does not occur and the selected threshold value is not considered in subsequent iterations.

17. The method according to claim 16, wherein for the threshold value to which a portion of transmission capacity has been assigned, the probability of non-admission of traffic is recalculated on the basis of the total transmission capacity assigned to the threshold value.

18. The method according to claim 14, wherein for the threshold value to which a portion of transmission capacity has been assigned, the probability of non-admission of traffic is recalculated on the basis of the total transmission capacity assigned to the threshold value.

19. The method according to claim 14, wherein the portion of transmission capacity for assignment to the threshold value is set according to the portion of the expected traffic volume.

20. The method according to claim 14, wherein the portion of transmission capacity is set to a minimum link capacity increment or proportional to the portion of the expected traffic volume.

21. The method according to claim 20, wherein a product value is the product of the portion of the expected traffic volume and the quotient of the total spare capacity on a link and an aggregated expected traffic volume on that link.

22. The method according to claim 21, wherein the portion of transmission capacity is set proportional to the product value.

23. The method according to claim 22,
wherein the portion of transmission capacity is set to the product value,
wherein the probability of non-admission of traffic in the case of an admission control via the threshold value after being assigned the corresponding portion of transmission capacity is calculated,
wherein for a set of threshold values used for admission controls, a portion of transmission capacity is defined via of product value and the associated probability of non-admission is calculated, and
wherein the portion of transmission capacity is decremented step by step and the corresponding probability of non-admission of traffic in the case of admission control via the threshold value is recalculated until the of non-admission of traffic is greater than or equal to the calculated probabilities of non-admission of traffic in the case of admission control via the set of threshold values.

24. The method according to claim 21, further comprising providing a plurality of product values for the links and wherein the portion of transmission capacity is set proportional to the minimum product value.

25. The method according to claim 14,
wherein a value for the portion of transmission capacity is determine due to a failure of at least one node or at least one link, and
wherein the portion of transmission capacity is set to the minimum of the determined values.

26. The method according to claim 14, wherein due to a failure of at least one node or at least one link:
a value for the portion of transmission capacity is determined by setting the values for the portion of transmission capacity proportional to the product of
the portion of the expected traffic volume and the quotient of the total spare capacity on a link and an aggregated expected traffic volume on that link, and
the portion of transmission capacity is set equal to the minimum of the determined values.

27. The method according to claim 26, wherein for each links the values are determined and the portion of transmission capacity is set equal to the minimum of the determined values.

28. The method according to claim 26, wherein the portion of transmission capacity is set to a minimum capacity increment if the increment is greater than the portion of transmission capacity calculated.
